(19) United States
(12) Patent Application Publication
(10) Pub. No.: US 2009/0134327 A1
(43) Pub. Date: May 28, 2009

(54) Defect recognizing method, defect observing method, and charged particle beam apparatus

(76) Inventors: Yutaka Ikku, Chiba-shi (JP); Junichi Tashiro, Chiba-shi (JP); Makoto Sato, Chiba-shi (JP)

Correspondence Address: BRUCE L. ADAMS, ESQ;ADAMS & WILKS, 17 BATTERY PLACE - SUITE 1231, NEW YORK, NY, 10004, US

(21) Appl. No.: 12/290,619

(22) Filed: Oct. 31, 2008

(30) Foreign Application Priority Data
Nov. 1, 2007 (JP) 2007-285003

(51) Int. Cl. G01N 23/00; H01J 3/14

(52) U.S. Cl. 250/307; 250/306; 250/396 R

(57) ABSTRACT

There are provided a detecting step of detecting secondary charged particles generated from an observation area of a sample when an electron beam or a focused ion beam is emitted onto the observation area under a certain irradiation condition; an image forming step of forming a plurality of observation images acquired by dividing the observation area and having an equal periodic pattern, from the secondary charged particles detected in the detecting step; and a defect recognizing step of recognizing a defect in the observation area from information on a difference acquired by comparing the plurality of observation images formed in the image forming step. Additionally, the detecting step, the image forming step, and the defect recognizing step are performed even when the electron beam or the focused ion beam is emitted onto the observation area under an irradiation condition different from the certain irradiation condition.

### BACKGROUND OF THE INVENTION

The present invention relates to a defect recognizing method of detecting a defect in a circuit pattern of a semiconductor device, a defect observing method of observing the defect, and a charged particle beam apparatus used to realize the methods.

In a semiconductor device fabrication process, an inspection operation is performed as a method of managing a yield using a defect inspection apparatus in order to inspect defects such as attachment of a foreign matter which causes a device operation failure. The defect inspection apparatus inspects defects and stores information on the number and locations of defects in a defect file. In addition, on the basis of the stored information, operations of recognizing the defects or observing the defects in detail are performed using various microscope apparatuses, if necessary. Upon performing the operations of recognizing the defects or observing the defects in detail, a SEM (Scanning Electron Microscope) apparatus or a FIB (Focused Ion Beam) apparatus is used, as disclosed in Patent Documents 1 and 2.

Here, upon observing the defect with high magnification using the SEM apparatus or the FIB apparatus, there are obtained advantages of inspecting a filling defect of a conductive material in a short circuit between patterns of a lower layer or within a through hole which connects patterns between an upper layer and a lower layer and a voltage contrast defect (hereinafter, referred to as a VC defect) caused by inner electric characteristics such as non-conductivity occurring due to a shape defect of a through hole resulting from an etching residue in addition to a pattern defect of the inspection target surface or a particle defect (hereinafter, referred to as a surface defect).

[Patent Document 1] JP-A-10-294345

[Patent Document 2] JP-A-2000-314710

However, when the VC defect is inspected or observed using the SEM apparatus or the FIB apparatus, it is difficult to show an unevenness on a sample surface in some cases. Accordingly, there occurs a problem in that it is difficult to set an irradiation condition used when a beam is scanned and emitted in the inspecting operation.

That is, when the VC defect is inspected or the like using the SEM apparatus, for example, a value of beam current used upon generating an electron beam, a value of acceleration voltage used upon accelerating a beam, and a scanning speed used upon emitting a beam have to be set separately. The VC defect may be observed or not be observed depending on the setting condition. For that reason, a good inspection of the VC defect or a possibility of observing the defect depends on a capability of an operator who operates the SEM apparatus.

The invention is devised in view of such a circumstance, and an object of the invention is to provide a defect recognizing method of recognizing a defect, a defect observing method of observing the defect, and a charged particle beam apparatus used to realize the methods regardless of a capability of an operator even when a beginner as the operator operates.

### SUMMARY OF THE INVENTION

In order to solve the above mentioned problems, a defect recognizing method includes: a secondary charged particle detecting step of detecting secondary charged particles generated from an observation area of a sample when an electron beam or a focused ion beam is scanned and emitted onto the observation area under a certain irradiation condition; an image forming step of forming a plurality of observation images acquired by dividing the observation area and having an equal periodic pattern, from the secondary charged particles detected in the secondary charged particle detecting step; and a defect recognizing step of recognizing a defect in the observation area from information on a difference acquired by comparing the plurality of observation images obtained in the image forming step. The secondary charged particle detecting step, the image forming step, and the defect recognizing step are performed even when the electron beam or the focused ion beam is scanned and emitted onto the observation area under another irradiation condition different from the certain irradiation condition.

According to the invention, the defect is recognized in the observation area by scanning and emitting the electron beam or the focused ion beam onto the observation area under the different irradiation conditions, detecting the secondary charged particles generated from the observation area of the sample, and comparing the observation images obtained under the same irradiation conditions among the plurality of obtained observation images having the equal periodic pattern. In this way, it is possible to easily recognize the defect which was difficult to recognize when the electron beam or the focused ion beam is scanned and emitted under only one irradiation condition, since the defect on the observation area is basically recognized on the basis of the observation images obtained upon scanning and emitting the electron beam or the focused ion beam under the plurality of different irradiation conditions.

In order to solve the above mentioned problems, a defect recognizing method includes; an observation-area secondary charged particle detecting step of detecting secondary charged particles generated from an observation area of a sample when an electron beam or a focused ion beam is scanned and emitted onto the observation area a plurality of times under respective different irradiation conditions; an observation image forming step of forming a plurality of observation images from the secondary charged particles detected in the observation-area secondary charged particle detecting step under the respective different irradiation conditions; a reference-area secondary charged particle detecting step of detecting secondary charged particles generated from a reference area when the electron beam or the focused ion beam is scanned and emitted onto the reference area a plurality of times under the same irradiation conditions as the respective different irradiation conditions; a reference image forming step of forming a plurality of reference images from the secondary charged particles detected in reference-area secondary charged particle detecting step under the respective different irradiation conditions; and a defect recognizing step of recognizing a defect of the observation area from information on a difference acquired by comparing the observation images obtained in the observation image forming step to the reference images obtained in the reference image forming step under the same irradiation conditions.

According to the invention, the defect on the observation area is recognized by scanning and emitting the electron beam or the focused ion beam onto the observation area under the different irradiation conditions, detecting the secondary charged particles generated from the observation area and the reference area of the sample, and comparing the observation images obtained under the same irradiation conditions and the reference image among the plurality of obtained observation image and reference images. In this way, it is possible to easily recognize the defect which was difficult to recognize when the electron beam or the focused ion beam is scanned and emitted onto the observation area and the reference image under only one irradiation condition, since the defect on the observation area is basically recognized on the basis of the observation images and the reference images obtained upon scanning and emitting the electron beam or the focused ion beam onto the observation area and the reference image under the plurality of different irradiation conditions.

According to the defect recognizing method according to the invention, in the above mentioned defect recognizing method, when the defect cannot be recognized, it is preferable that the secondary charged particle detecting step, the image forming step, and the defect recognizing step are performed under an additional new different irradiation condition in a state where the electron beam or the focused ion beam is scanned and emitted onto the observation area.

According to the defect recognizing method according to the invention, in the above mentioned defect recognizing method, when the defect cannot be recognized, it is preferable that the observation-area secondary charged particle detecting step, the observation image forming step, and the reference-area secondary charged particle detecting step, the reference image forming step, and the defect recognizing step are performed under an additional new different irradiation condition in a state where the electron beam or the focused ion beam is scanned and emitted onto the observation area.

With such a configuration, even when the defect is not recognized, the defect is recognized in the observation area on the basis of the observation image and the reference image obtained by scanning and emitting the electron beam or the focused ion beam onto the observation area or the reference area under the additional new different conditions and detecting the secondary charged particles generated from the observation area, or the like. Accordingly, a possibility of recognizing the defect is improved.

In the defect recognizing method according to the invention, as the different irradiation condition, it is preferable that acceleration voltage applied to the electron beam or the focused ion beam is different.

With such a configuration, since it is possible to vary a beam energy required when the charged particle beam collides the observation area and the reference area of the sample, the defect which cannot be recognized due to a very large energy or a very small energy of the charged particle beam can be recognized by adjusting the energy of the charged particle beam so as to be appropriate. In particular, when the VC defect is in a deep location from the sample surface, the defect can be easily recognized by setting the acceleration voltage to be appropriate.

In the defect recognizing method according to the invention, as the different irradiation condition, it is preferable that an amount of beam current is different.

The amount of beam current has to be adjusted so as to generate the secondary charge particles in order to form an image when the charged particle beam is emitted onto the sample, and thus it is preferable that the amount of beam current is large. However, when the amount of beam current is too large, it is difficult to obtain a clear image because the image becomes blurred. Moreover, there occurs a problem with a local charge-up. Accordingly, it is important to set an appropriate amount of beam current in recognition of the defect.

In the defect recognizing method according to the invention, it is preferable that the amount of beam current is switched from a smaller amount to a larger amount upon allowing the amount of beam current to be different.

With such a configuration, it is possible to avoid the problem with the local charge-up when the charged particle beam is emitted to the observation area or the reference area of the sample.

In the defect recognizing method according to the invention, as the different irradiation condition, it is preferable that a beam scanning speed is different.

With such a configuration, it is possible to recognize the defect which cannot be recognized due to a very rough image caused due to a speedy beam scanning speed. Accordingly, a clear image can be obtained by setting an appropriate scanning speed.

In the defect recognizing method according to the invention, it is preferable that the beam scanning speed is switched from a faster speed to a slower speed upon allowing the beam scanning speed to be different.

With such a configuration, it is possible to avoid the problem with the local charge-up when the charged particle beam is emitted to the observation area or the reference area of the sample.

According to the invention, a defect observing method includes: processing a cross section of the defect recognized by the above mentioned defect recognizing method with a focused ion beam; scanning and emitting an electron beam or the focused ion beam onto the processed cross section; and observing the processed cross section.

In the defect recognizing method according to the invention, it is possible to directly observe the cross section of the defect by recognizing the defect, processing the cross section of the defect with the focused ion beam and scanning and emitting the electron beam or the focused ion beam onto the processed cross section.

According to the invention, a charged particle beam apparatus includes: an electron beam column which scans and emits an electron beam onto a sample; an ion beam column which scans and emits an ion beam onto the sample; a sample stage on which the sample is put; a detector which detects secondary charged particles generated when the charged particle beam emitted from the electron beam column or the ion beam column is scanned and emitted onto the sample; irradiation condition determining means which prepares a plurality of irradiation conditions when the charged particle beam from the electron beam column or the ion beam column is scanned and emitted, and supplies information on the irradiation conditions to the electron beam column or the ion beam column; and defect recognizing means which recognizes a defect of the sample by obtaining images of the sample from the detected secondary charged particles and comparing the images obtained under the same irradiation conditions prepared by the irradiation condition determining means among the obtained images.

In the charged particle beam apparatus according to the invention, the defect recognizing method and the defect observing method described above can be appropriately performed.

In the charged particle beam apparatus according to the invention, it is preferable that the defect recognizing means includes a determination unit which transmits a command signal indicating preparation of a new different irradiation condition to the irradiation condition determining means when the defect cannot be recognized.

With such a configuration, an automatic operation of recognizing the defect can be performed with the charged particle beam apparatus.

### ADVANTAGE OF THE INVENTION

According to the invention, it is possible to recognize a defect irrespective of the capability of an operator even when a beginner as the operator operates.

### BRIEF DESCRIPTION OF THE DRAWINGS

FIG. 1 is a diagram illustrating an overall configuration of a charged particle beam apparatus according to an embodiment of the invention.

FIG. 2 is a sectional view illustrating an overall configuration of the charged particle beam apparatus according to the embodiment of the invention.

FIG. 3 is a diagram illustrating an overview of a control device of the charged particle beam apparatus according to the embodiment of the invention.

FIG. 4 is a flowchart illustrating a defect recognizing method a according to the embodiment of the invention.

FIG. 5 is a flowchart illustrating a defect recognizing method according to the embodiment of the invention.

### DETAILED DESCRIPTION OF THE INVENTION

Hereinafter, a charged particle beam apparatus will be described with reference to the drawings according to an embodiment of the invention.

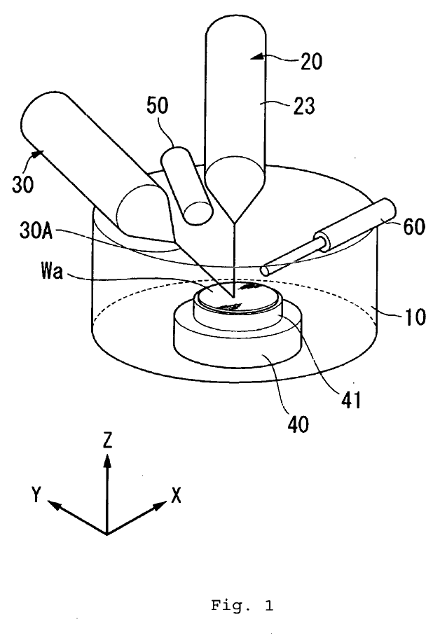

FIG. 1 is a schematic perspective view illustrating the charged particle beam apparatus according to the invention.

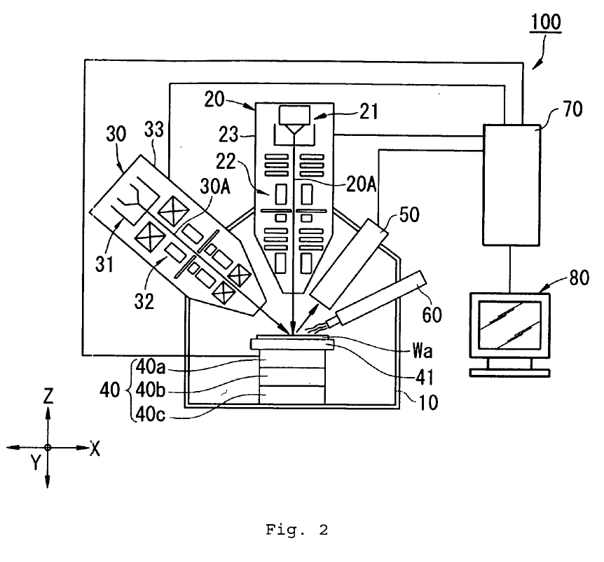

FIG. 2 is a schematic sectional view illustrating a charged particle beam apparatus 100.

According to the embodiment, as illustrated in FIGS. 1 and 2, the charged particle beam apparatus 100 includes a vacuum chamber 10, an ion beam irradiating system 20, an electron beam irradiating system 30, a sample stage 40, a secondary charged particle detector 50, and a gas gun 60. The vacuum chamber 10 is configured so as to depressurize the inside up to a predetermined vacuum level. The whole or some of constituent elements are disposed within the vacuum chamber 10.

The ion beam irradiating system 20 includes an ion source 21 which generates ions and an ion optics system 22 which focuses the ions emitted from the ion source 21 to form an ion beam and scans the ion beam. The ion beam irradiating system 20 including an ion beam column 23 emits ion beam (focused ion beam) 20A onto a sample Wa on the sample stage 40 disposed within the vacuum chamber 10. Then, secondary charged particles such as secondary ions or secondary electrons are generated from the sample Wa. The secondary charged particle detector 50 detects the secondary charged particles to acquire an image of the sample Wa.

As illustrated in FIG. 2, the electron beam irradiating system 30 includes an electron source 31 which emits electrons and an electron optics system 32 which focuses the ions emitted from the electron source 31 to form an electron beam and scans the electron beam. When the electron beam irradiating system 30 irradiates the sample Wa with an electron beam 30A, secondary electrons are generated from the sample Wa. Then, the secondary charged particle detector 50 detects the secondary generated electrons to obtain the image of the sample Wa. The electron beam 30A emitted from an electron beam column 33 is emitted onto a location, which is the same location emitted with the ion beam 20A, on the sample Wa.

The ion optics system 22 includes a capacitor lens which focuses the ion beam, an aperture which squeezes the ion beam, an aligner which aligns an optical axis of the ion beam, an object lens which focuses the ion beam onto the sample, and a deflector which scans the ion beam onto the sample.

The sample stage 40 movably holds a sample table 41. On the sample table 41, the sample Wa (for example, semiconductor wafer) is fixed on a holder. In addition, the sample stage 40 is capable of displacing the sample table 41 in five axes directions. That is, the sample stage includes an XYZ movement mechanism 40b which moves the sample table 41 in X and Y axes directions perpendicular to each other and parallel to a horizontal plane and in a Z axis direction perpendicular to the X axis and Y axis directions, a rotation mechanism 40c which rotates the sample table 41 in the Z axis direction, and a tilt mechanism 40a which rotates the sample table 41 in the X axis (or Y axis) direction. The sample stage 40 is configured so that a specific location of the sample Wa is moved to a location irradiated with the ion beam by displacing the sample table 41 in the five axes directions.

The vacuum chamber 10 is configured so as to depressurize the inside up to the predetermined vacuum level. The sample table 41, the secondary charged particle detector 50, and the gas gun 60 are provided in the vacuum chamber 10.

The secondary charged particle detector 50 detects the secondary electrons or the secondary ions generated from the sample Wa, when the ion beam irradiating system 20 emits the ion beam 20A or the electron beam irradiating system 30 emits the electron beam 30A onto the sample Wa.

The gas gun 60 emits a predetermined gas such as an etching gas or a deposition gas onto the sample Wa.

An etching speed for the sample by the ion beam can be increased by emitting the ion beam 20A onto the sample Wa while supplying the etching gas from the gas gun 60. On the other hand, a deposition of a metal or an insulation material can be formed on the sample Wa upon emitting the ion beam onto the sample Wa while supplying the deposition gas from the gas gun 60.

The charged particle beam apparatus 100 further includes a control device 70 which controls constituent elements of the charged particle beam apparatus. The control device 70 is connected to the ion beam irradiating system 20, the electron beam irradiating system 30, the secondary charged particle detector 50, and the sample stage 40. In addition, there is further provided a display device 80 which displays a sample image acquired on the basis of signals detected from the secondary charged particle detector 50.

The control device 70 controls the charged particle beam apparatus 100 on the whole, generates image data by converting the secondary charged particles detected by the secondary charged particle detector 50 into brightness signals, and forms an image on the basis of the image data to output the image to the display device 80. In this way, the display device 80 displays an observation image or a reference image of the sample, as described above.

The control device 70 drives the sample stage 40 on the basis of a software command or input of an operator and adjusts the position or posture of the sample Wa. In this way, an irradiation location or an irradiation angle of the ion beam on a sample surface is adjusted. For example, the sample Wa is moved or tilted by driving the sample stage 40 in conjunction with an operation switching between the ion beam irradiation system 20 and the electron beam irradiation system 30.

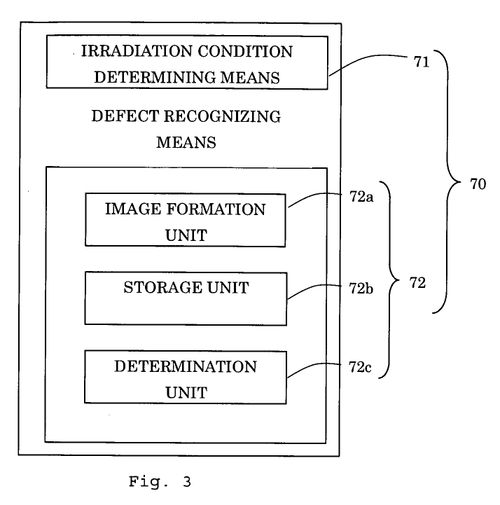

As illustrated in FIG. 3, the control device 70 includes irradiation condition determining means 71 which prepares a plurality of irradiation conditions used to irradiate the charged particle beam from the electron beam column 33 or the ion beam column 23 and supplies information on the irradiation conditions to the electron beam column 33 or the ion beam column 23; and defect recognizing means 72 which obtains the observation images of the sample from the secondary charged particles detected by the secondary charged particle detector 50 and detects a defect of the sample by comparing the observation images having the same irradiation conditions obtained from the irradiation condition determining means among the acquired observation images.

The defect recognizing means 72 includes an image formation unit 72a which forms the observation images of the sample from the secondary charged particles detected by the secondary charged particle detector 50, a storage unit 72b which stores data on the images formed by the image formation unit or stores information on the defect of the sample, and a determination unit 72c which determines on the basis of the images formed by the image formation unit 72a whether the sample has a defect.

Next, there will be described a method of recognizing the defect of the sample Wa and a method of carrying out an observing while separating the recognized defect with the charged particle beam apparatus 100 having the above-described configuration according to the embodiment.

[Defect Recognizing Method]

This embodiment provides two defect recognizing methods. One is a method of recognizing the defect of the sample Wa by obtaining an image in which a certain pattern is continuous a uniform period, dividing the image into plurality of images so as to have an equal pattern, and comparing the divided images. The other is a method of recognizing the defect by obtaining an image of a defect portion and an image of another reference portion (normal portion) in a state of knowing the defect in advance and comparing the images.

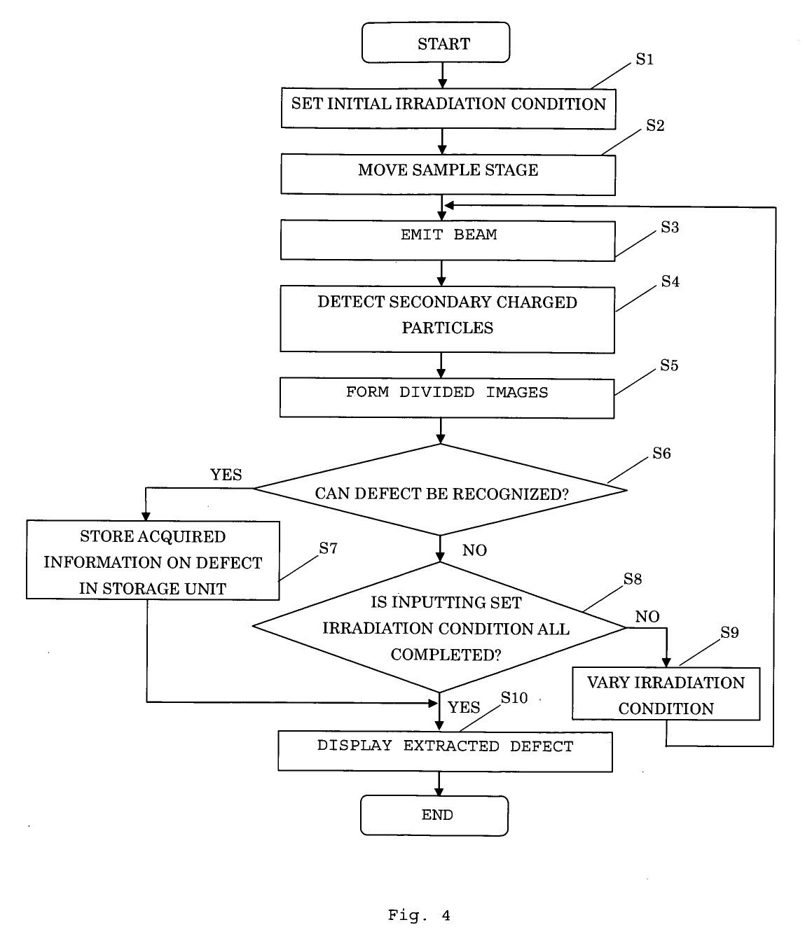

First, a first defect recognizing method will be described with reference to FIG. 4. FIG. 4 is a flowchart illustrating an operation sequence performed in the control device 70.

Beam irradiation conditions are set in the irradiation condition determining means 71 in accordance with a type of the sample Wa to be recognized, a shape of a circuit pattern, and the like which are input in advance. For example, examples of the beam irradiation condition include a type of beam, a beam scanning speed, acceleration voltage, and an amount of beam current. Here, whether the type of beam is the ion beam or the electron beam is set and predetermined values of the beam scanning speed and the acceleration voltage are set on the basis of data input in advance. In addition, the amount of the beam current is set so as to vary from a smaller value to a larger value in stages (Step 1).

Subsequently, on the basis of the information on the defect stored in advance in the control device 70, the sample stage 40 on which the sample Wa is set is moved so that the charged particle beam arrives to the observation area having the defect of the sample Wa (Step 2). In addition, the sequence of Steps 1 and 2 may be reversed.

The electron beam 30A is emitted from the electron beam irradiation system 30 onto the observation area of the sample Wa, for example, in accordance with the irradiation conditions of the set type of beam, the beam scanning speed, the acceleration voltage, and an initial small amount of beam current (Step 3).

At this time, the secondary charged particles such as the secondary electrons are generated from the observation area of the sample Wa, and the secondary charged particles are detected by the secondary charged particle detector 50 (secondary charged particle detecting step: Step 4).

An image of the observation area is formed from the secondary charged particles which have been detected by the image formation unit 72a. The formed image is additionally divided into a plurality of observation images having an equal periodic pattern (image formation step: Step 5). In this case, the process of forming the image of the observation area from the secondary charged particles and the process of dividing the image are performed in accordance with a known image processing method.

Subsequently, the determination unit 72c compares the plurality of divided observation image acquired in Step 5 and recognizes the defect from information on variation in the brightness of the observation images (defect recognizing step: Step 6). Specifically, whether the defect is present depends on whether the variation in the brightness of the compared images exceeds a preset threshold value.

When the defect is recognized, the divided observation image having the defect and the compared and divided reference image (normal image), if necessary, are stored in the storage unit 72b (Step 7).

When the defect is present, the information on the defect is stored. When the defect is not recognized, Step 8 proceeds. Here, it is determined whether inputting the image under the set irradiation conditions is all completed.

When inputting the image input under the set irradiation conditions is not all completed, Step 9 proceeds. At this time, the set values of the beam scanning speed and the acceleration voltage are maintained and the amount of beam current is set to have a value larger than the previously set value by a predetermined amount, so that Steps 1 to 8 are repeatedly performed.

Alternatively, when inputting the image under the set irradiation conditions is all completed, Step 10 proceeds. Image information stored in the storage unit 72b is read and displayed on the display device 80.

According to the first defect recognizing method described above, the defect on the observation area is recognized on the basis of the observation image obtained when the electron beam or the focused ion beam is emitted on the observation area under the plurality of different irradiation conditions. Therefore, it is possible to easily recognize the defect which is difficult to recognize when the electron beam or the focused ion beam is emitted under only one irradiation condition. Accordingly, the defect can be recognized regardless of the fact that the operator is either a beginner or an expert.

Subsequently, the focused ion beam is emitted onto the detect portion, if necessary, the detect portion is subjected to cut processing, and the electron beam or the focused ion beam is emitted onto the processed cross section to observe the processed cross section.

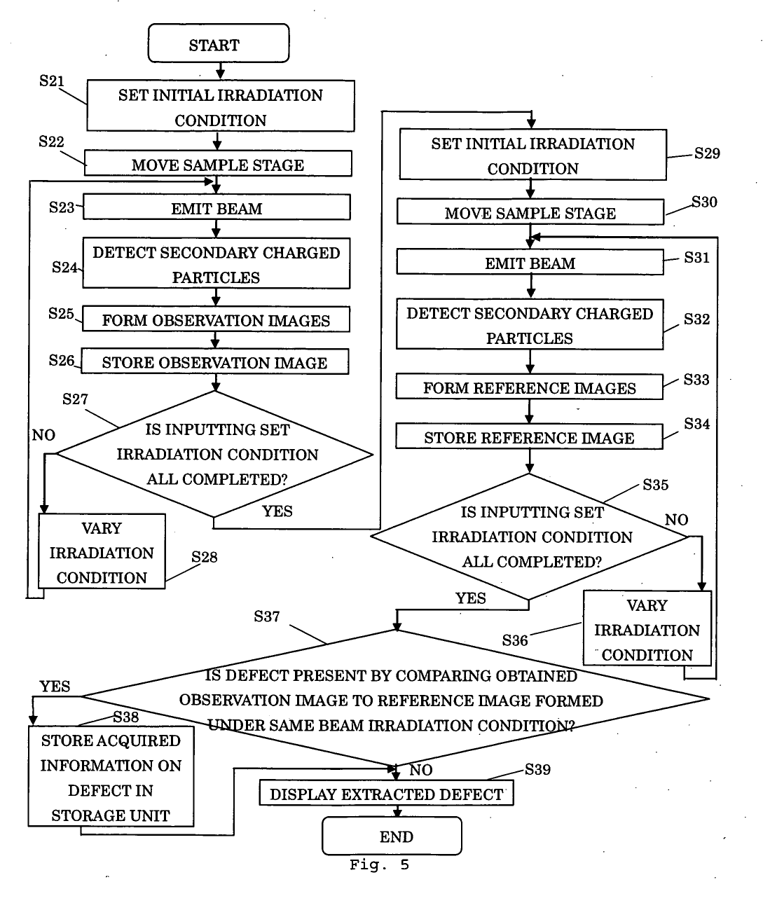

Next, a second defect recognizing method will be described with reference to FIG. 5. FIG. 5 is a flowchart illustrating operations performed by the control device 70.

First, the irradiation condition determining means 71 sets the beam irradiation condition in accordance with the type of the sample Wa to be recognized, the shape of the circuit pattern, or the like which are input in advance. For example, whether the type of beam is the ion beam or the electron beam is set and predetermined values of the beam scanning speed and the acceleration voltage are set on the basis of data input in advance. In addition, the amount of the beam current is set so as to vary from a smaller value to a larger value in stages (Step 21).

Subsequently, on the basis of the information on the defect stored in advance in the control device 70, the sample stage 40 on which the sample Wa is put is moved so that the charged particle beam arrives to the observation area having the defect of the sample Wa (Step 22). In addition, the sequence of Steps 21 and 22 may be reversed.

The electron beam is emitted from the electronic beam irradiation system 30 onto the observation area of the sample Wa, for example, in accordance with the irradiation conditions of the set type of beam, the beam scanning speed, the acceleration voltage, and the initial small amount of beam current (Step 23).

At this time, the secondary charged particles are generated from the observation area of the sample Wa, and the secondary charged particles are detected by the secondary charged particle detector 50 (observation-area secondary charged particle detecting step: Step 24).

Subsequently, an image of the observation area is formed from the detected secondary charged particles (observation image formation step: Step 25).

Subsequently, the observation image obtained in Step 25 and the irradiation condition at that time are stored in the storage unit 72b (Step 26).

Subsequently, in Step 27, it is determined whether inputting the image under the set irradiation condition is all completed.

When inputting the image input under the set irradiation conditions is not all completed, Step 28 proceeds. At this time, the set values of the beam scanning speed and the acceleration voltage are maintained and the amount of beam current is set to have a value larger than the previously set value by a predetermined amount, so that Steps 23 to 27 are repeatedly performed.

Alternatively, when inputting the image under the set irradiation conditions is all completed, Step 29 proceeds. Then, the irradiation condition set upon obtaining the initial observation image is reset.

Subsequently, in Step 30, the sample stage 40 is moved and operated so that the charged particle beam is emitted onto a reference area where the defect of the sample Wa is not present.

The electron beam is emitted from the electronic beam irradiation system 30 onto the reference area of the sample, for example, in accordance with the irradiation conditions of the set type of beam, the beam scanning speed, the acceleration voltage, and the initial small amount of beam current (Step 31).

At this time, the secondary charged particles are generated from the reference area, and the secondary charged particles are detected by the secondary charged particle detector 50 (reference-area secondary charged particle detecting step: Step 32).

Subsequently, an image of the reference area is formed from the detected secondary charged particles (reference image formation step: Step 33).

Subsequently, the obtained reference image and the irradiation condition at that time are stored in the storage unit 72b (Step 34).

Subsequently, in Step 35, it is determined whether inputting the image under the set irradiation condition is all completed.

When inputting the image input under the set irradiation conditions is not all completed, Step 36 proceeds. At this time, the set values of the beam scanning speed and the acceleration voltage are maintained and the amount of beam current is set to have a value larger than the previously set value by a predetermined amount, like the case of emitting the beam onto the observation area, so that Steps 31 to 35 are repeatedly performed.

Alternatively, when inputting the image under the set irradiation conditions is all completed, Step 37 proceeds. Then, by comparing the images obtained under the same irradiation conditions to each other among the observation image and the reference image stored in the storage unit 72b, the defect of the observation area is recognized from information on variation in the brightness of the images (defect recognizing step).

When the defect is present in the observation area, information on the defect is all stored in the storage unit 72b (Step 38). Next, the information on the defect stored on the storage unit 72b is read and displayed on the display device 80 (Step 39).

According to the second defect recognizing method described above, the defect on the observation area is recognized on the basis of the observation image and the reference area acquired when the electron beam or the focused ion beam is emitted on the observation area under the plurality of different irradiation conditions. Therefore, it is possible to easily recognize the defect which is difficult to recognize when the electron beam or the focused ion beam is emitted under only one irradiation condition. Accordingly, the defect can be recognized regardless of the fact that the operator is either a beginner or an expert.

Subsequently, the focused ion beam is emitted onto the defect portion, if necessary, the defect portion is subjected to cut processing, and the electron beam or the focused ion beam is emitted onto the processed cross section to observe the processed cross section like the first defect recognizing method described above.

In the above description, the type of beam, the beam scanning speed, the acceleration voltage as the initial beam irradiation condition are set respectively to have a value, and the amount of beam current varies from the smaller value to the larger value in stages. However, the invention is not limited thereto. The type of beam may be set and the beam scanning speed and the amount of beam current may be set respectively to have a predetermined value. In addition, the acceleration voltage may be set to vary from a smaller value to a larger value in stages, for example. In addition, the amount of beam current and the acceleration voltage may be set respectively to have a predetermined value, and the beam scanning speed may be set to vary from a larger value to a smaller value in stages, for example. The amount of beam current may vary from the smaller value to the larger value in stages in a linear manner or an exponential manner. The number of the variation may be two or more, and the number is not restrictive.

The beam for irradiating the sample is not limited to the electron beam, but the ion beam may be used. In this case, a secondary ion detector may be used as the secondary charged particle detector.

During the above-described steps, when the determination unit 72c determines whether the defect is recognized and then determines that the defect is recognized, a series of the image obtaining step and the defect recognizing step under the different irradiation condition may be omitted.

What is claimed is:

1. A defect recognizing method comprising:
a secondary charged particle detecting step of detecting secondary charged particles generated from an observation area of a sample when an electron beam or a focused ion beam is scanned and emitted onto the observation area under a certain irradiation condition;
an image forming step of forming a plurality of observation images acquired by dividing the observation area and having an equal periodic pattern, from the secondary charged particles detected in the secondary charged particle detecting step; and
a defect recognizing step of recognizing a defect in the observation area from information on a difference acquired by comparing the plurality of observation images obtained in the image forming step,
wherein the secondary charged particle detecting step, the image forming step, and the defect recognizing step are performed even when the electron beam or the focused ion beam is scanned and emitted onto the observation area under another irradiation condition different from the certain irradiation condition.

2. A defect recognizing method comprising;
an observation-area secondary charged particle detecting step of detecting secondary charged particles generated from an observation area of a sample when an electron beam or a focused ion beam is scanned and emitted onto the observation area a plurality of times under respective different irradiation conditions;
an observation image forming step of forming a plurality of observation images from the secondary charged particles detected in the observation-area secondary charged particle detecting step under the respective different irradiation conditions;
a reference-area secondary charged particle detecting step of detecting secondary charged particles generated from a reference area when the electron beam or the focused ion beam is scanned and emitted onto the reference area a plurality of times under the same irradiation conditions as the respective different irradiation conditions;
a reference image forming step of forming a plurality of reference images from the secondary charged particles detected in the reference-area secondary charged particle detecting step under the respective different irradiation conditions; and
a defect recognizing step of recognizing a defect of the observation area from information on a difference acquired by comparing the observation images obtained in the observation image forming step to the reference images obtained in the reference image forming step under the same irradiation conditions.

3. The defect recognizing method according to claim 1; wherein when the defect is not recognized, the secondary charged particle detecting step, the image forming step, and the defect recognizing step are performed in a state where the electron beam or the focused ion beam is scanned or emitted onto the observation area under an additional new irradiation condition different from the irradiation conditions.

4. The defect recognizing method according to claim 2; wherein the defect is not recognized, the observation-area secondary charged particle detecting step, the observation image forming step, the reference-area secondary charged particle detecting step, the reference image forming step, and the defect recognizing step are performed in a state where the electron beam or the focused ion beam is scanned or emitted onto the observation area under an additional new irradiation condition different from the irradiation conditions.

5. The defect recognizing method according to claim 1, wherein the different irradiation condition is that acceleration voltage applied to the electron beam or the focused ion beam is different.

6. The defect recognizing method according to claim 2, wherein the different irradiation condition is that acceleration voltage applied to the electron beam or the focused ion beam is different.

7. The defect recognizing method according to claim 1, wherein the different irradiation condition is that an amount of beam current is different.

8. The defect recognizing method according to claim 2, wherein the different irradiation condition is that an amount of beam current is different.

9. The defect recognizing method according to claim 7, wherein upon allowing the amount of beam current to be different, the amount of beam current is switched from a smaller amount to a larger amount.

10. The defect recognizing method according to claim 8, wherein upon allowing the amount of beam current to be different, the amount of beam current is switched from a smaller amount to a larger amount.

11. The defect recognizing method according to claim 1, wherein the different irradiation condition is that a beam scanning speed is different.

12. The defect recognizing method according to claim 2, wherein the different irradiation condition is that a beam scanning speed is different.

13. The defect recognizing method according to claim 11, wherein upon allowing the beam scanning speed to be different, the beam scanning speed is switched from a faster speed to a slower speed.

14. The defect recognizing method according to claim 12, wherein upon allowing the beam scanning speed to be different, the beam scanning speed is switched from a faster speed to a slower speed.

15. A defect observing method comprising:
processing a cross section of the defect recognized by the defect recognizing method according to claim 1 with a focused ion beam;
scanning and emitting an electron beam or the focused ion beam onto the processed cross section; and
observing the processed cross section.

16. A defect observing method comprising:
processing a cross section of the defect recognized by the defect recognizing method according to claim 2 with a focused ion beam;
scanning and emitting an electron beam or the focused ion beam onto the processed cross section; and
observing the processed cross section.

17. A charged particle beam apparatus comprising:
an electron beam column which scans and emits an electron beam onto a sample;
an ion beam column which scans and emits an ion beam onto the sample;
a sample stage on which the sample is put;
a detector which detects secondary charged particles generated when the charged particle beam emitted from the electron beam column or the ion beam column is scanned and emitted onto the sample;
irradiation condition determining means which prepares a plurality of irradiation conditions when the charged particle beam from the electron beam column or the ion beam column is scanned and emitted, and supplies information on the irradiation conditions to the electron beam column or the ion beam column; and
defect recognizing means which recognizes a defect of the sample by obtaining images of the sample from the detected secondary charged particles and comparing the images obtained under the same irradiation conditions prepared by the irradiation condition determining means among the obtained images.

18. The charged particle beam apparatus according to claim 17, wherein the defect recognizing means includes a determination unit which transmits a command signal indicating preparation of a new different irradiation condition to the irradiation condition determining means when the defect cannot be recognized.
